(19) United States
(12) Patent Application Publication
(10) Pub. No.: US 2019/0086158 A1
(43) Pub. Date: Mar. 21, 2019

(54) Cooling Sticker For Cooling Hot Spots In Cellular Telephones

(71) Applicant: James Hirschfeld, Delray Beach, FL (US)

(72) Inventor: James Hirschfeld, Delray Beach, FL (US)

(21) Appl. No.: 15/707,986

(22) Filed: Sep. 18, 2017

(51) Int. Cl. F28D 15/02; F28F 23/00; H04M 1/02

(52) U.S. Cl. CPC F28D 15/0275; F28F 23/00; F28D 2021/0028; F28F 2275/025; H04M 1/0202

(57) ABSTRACT

A removable cooling sticker secured to the surface of a cellular telephone for extraction of heat from the cellular telephone. The cooling sticker is thin and sized to be conveniently carried. The cooling sticker is adhered to the cellular telephone at its hot spot for maximum efficiency. An optional feature employs thermal strips that indicate when the electronic device is exceeding a temperature threshold sticker

### BACKGROUND

### CROSS-REFERENCE TO RELATED APPLICATIONS

This application is related to, and claims the benefit of, the provisional patent application, now expired, entitled “Apparatus and Method for Cooling Portable Electronic Devices”, filed Nov. 25, 2014, bearing U.S. Ser. No. 62/084,331 and naming James Hirschfeld, the named inventor herein, as sole inventor, and the non-provisional patent application, currently pending, entitled “Apparatus and Method for Cooling Portable Electronic Devices”, filed Jul. 21, 2015, bearing U.S. Ser. No. 14/805,224 and naming James Hirschfeld, the named inventor herein, as sole inventor, the contents of each is specifically incorporated by reference herein in its entirety.

### TECHNICAL FIELD

This invention relates in general to cellular telephones. In particular, it relates to a disposable cooling sticker that adheres to the exterior of a cellular telephone above the battery. The cooling sticker extracts heat from the surface of the cellular telephone and prevents the cellular telephone from overheating, and optionally provides a thermal strip to give a visual indication of the device's temperature so that the individual using a cellular telephone will have an indication when the cooling sticker needs to be installed or replaced because the cellular telephone is overheating.

BACKGROUND OF THE INVENTION

The vast majority of people use cellular telephones on a regular basis. Since these devices are typically battery-powered, the internal power supply often results in generation of substantial undesirable heat. In addition, while these devices provide substantial convenience and productivity advantages for individuals, they are often used in environments where it is difficult to control ambient temperature. As a result, overheating frequently causes problems for the user, such as errors, data loss, device shutdown, and even damage to the device due to overheating.

The prior art attempted to address heating problems in electronic devices in several ways. One such attempt has been the use of supports, such as platforms, that contain integral fans that direct enhanced airflow to the bottom of the portable electronic device. These devices have several disadvantages. For example, fan based platforms typically require the platform to be plugged into a power source such as a wall outlet. As a result, portability is lost. Another disadvantage associated with this solution is that the platforms typically are designed for a specific type of electronic device. A platform designed to accommodate a particular make and model of a portable computer, such as a laptop or notebook, will often not be the correct size and configuration for a different make or model. Of course, a fan based platform system would be entirely unsuitable for devices such as a cellular phone, a tablet computer, or some other special-purpose electronic device. It would be desirable to have a method of cooling cellular telephones in locations where environmental factors exacerbate heating problems.

It would be further desirable to have a method of cooling a cellular telephone that is small in size and weight, such that it is convenient for users to carry.

Yet another drawback to the prior art is that existing cooling devices are typically attached at all times when traveling. This is not desirable when ambient temperatures are such that heat is not a problem. It would be desirable to have a cooling device that could be easily and conveniently attached to a cellular telephone only when it is needed. For example, when a cellular telephone is used indoors or in an air conditioned environment, cooling may not be needed, but when used in a warm environment, such as outdoors in summer, it would be useful.

An alternative to the fan-based cooling systems has been the development of systems that incorporate cold material, such as what is referred to as commercially available “blue ice” cooling block. While this provides some cooling capacity, this type of system typically provides substantial bulk and weight. In addition, once the cooling block has thawed it loses its capacity for cooling, and furthermore, it is too bulky and heavy for a user to carry multiple cooling blocks. It would be desirable to have a cooling device that is small enough and light enough such that the user could conveniently carry multiple cooling devices.

Another problem associated with the prior art is that solutions such as blue ice don't effectively provide cooling because they are not always in direct contact with the cellular telephone in question. It would be desirable to have a cooling mechanism that is in contact with the surface of the hotspot on the cellular telephone to ensure the maximum effectiveness of heat transfer. The hotspot is typically around the location of the battery. In particular, it would be desirable to have a cooling device that can be attached to a specific location on the cellular telephone. For example, the cooling device would be more effective if sized and placed on the hot spot of a cellular telephone rather than over a larger area that doesn't require cooling.

While the prior art has provided various solutions to the problem of overheating electronic devices, the prior art solutions are typically bulky, heavy, and require either an external power source, or are only useful while the large heavy cooling block is effective. None of them provide an effective solution for cellular telephones. It would be desirable to have a device that will effectively cool the cellular telephone while having low weight, size, and portability.

### SUMMARY OF THE INVENTION

This invention provides a removable cooling sticker that can be secured to the surface of a cellular telephone to extract heat from it. The cooling sticker is preferably fabricated using phase change material that has an insulation layer away from the surface in contact with the cellular telephone. The surface in contact with the cellular telephone is preferably fabricated with an efficient thermal conductor such as a metalized foil. Between the insulation layer and the metalized layer is a core layer of lightweight graphene nanoplatelets and polyaniline. The cooling pad is thin and sized to fit electronic devices of many sizes. Further, one or more cooling pads are independently attachable to the surface of a cellular telephone at the cellular telephone's hot spot(s) for maximum efficiency. A further optional feature employs thermal strips that indicate when the electronic device is exceeding a temperature threshold.

### BRIEF DESCRIPTION OF THE DRAWINGS

FIG. 1 illustrates a bottom plan view of a preferred embodiment of a cellular telephone showing a hot spot.

FIG. 2 illustrates a bottom plan view of a preferred embodiment of a cellular phone with a cooling sticker secured to its rear surface.

FIG. 3 illustrates an edge view of a preferred embodiment of the cooling sticker showing the layered structure.

FIG. 4 illustrates a bottom plan view of a cellular telephone with a thermal strip for indicating the temperature of the device.

### DETAILED DESCRIPTION OF THE PREFERRED EMBODIMENT

Prior to a discussion of the figures, a general overview of the invention will be provided. The invention provides cooling stickers that can be secured to the surface of a cellular telephone much like a Band-Aid™ secures to an individual's skin. The cooling stickers are thin and lightweight which allows multiple cooling stickers to be carried for use when needed. When a user determines that the cellular telephone in use is running hot or beginning to overheat, the cooling pad is secured to the electronic device for the purpose of transferring heat out of the device. Likewise, an optional thermal strip can be attached to the cellular telephone to indicate its temperature. Thermal strips are well known in the art.

An additional advantage of using cooling stickers that are adhered to the surface of the cellular telephone is that the cooling sticker can be applied to the surface at the precise point where heat is greatest rather than applying the pad to the entire device such that it covers areas that do not need cooling. The cooling stickers provide an extended period of time to prevent electronic devices from overheating. This can be important when the device is in hostile environments, such as outdoors in hot weather.

The physical size of the cooling sticker is an important advantage of the invention because it is very thin and lightweight. This allows multiple cooling pads to be carried so that the cooling time can be extended for longer periods of time. The small size of the cooling pads allows them to be conveniently carried in a computer bag, a telephone cover, a briefcase, a wallet, a pocket, etc.

In a preferred embodiment, the cooling pads are constructed of thermal-composites and insulation that serve to transfer excess heat from the cellular telephone to bring the devices temperature into its thermal operating profile range.

A preferred embodiment uses chemical cooling pads that the user activates when needed. The chemical reaction in the cooling stickers provides cooling to the cellular telephone when they are attached to the cellular telephone. An advantage of this embodiment is that it does not require any external power and requires a minimum amount of space. Preferably, the cooling sticker would be 1/16 of an inch thick. However, the thickness can vary based on the amount of cooling capacity desired.

Depending on the type of cellular telephone being used, the surface area will vary. The size selected by the user would depend on the particular cellular telephone in question. Of course, cooling stickers for smaller devices would require less surface area to be covered. The advantage of a chemical-based cooling sticker is that it does not require any external power source. Once the chemical reaction is complete, and the cooling pad starts to decline in effectiveness, it can be peeled off of the electronic device and replaced with a fresh cooling sticker. Being able to replace the cooling stickers at will allows a cellular telephone to have an extended cooling period when traveling or outside of a fixed location.

In a preferred embodiment, the cooling sticker is fabricated using phase change material (PCM) that changes from solid to liquid and then back for the purpose of storing and releasing large amounts of thermal energy. In addition, thermal composites can be used that combine PCMs with other solid structures, such as copper mesh immersed in paraffin. PCMs have a high heat of fusion. Because of that, they change from solid to liquid based on exposure to varying levels of heat. The process of melting and solidifying at a certain temperatures allows PCMs to store and release significant amounts of thermal energy. Heat is absorbed or released when the material changes between solid and liquid states.

The preferred embodiment envisions an optional insulation layer on the surface of the cooling sticker (the distal surface) that is opposite to the surface in contact with the device (the proximal surface). The preferred embodiment uses commercially available Lumira aerogel™ in particle or pellet form. The cooling pad is fabricated with the Lumira aerogel concentrated on the distal surface of the cooling pad. In addition, the proximal surface of the cooling pad preferably has a metalized mylar or other foil to maximize heat transfer from the cellular telephone to the cooling sticker.

The cooling sticker structure has a core layer of PCM material between the distal and proximal layers of the cooling sticker. The core layer is fabricated from lightweight polyaniline, commercially available from Sigma-Aldrich™, and graphene nanoplatelets, commercially available from xGnP™.

The cooling sticker can be attached to a cellular telephone by any suitable means, such as adhesive, double stick tape, etc.

An optional feature of the invention provides an integrated liquid crystal thermometer that provides the user with the visual indication of the current temperature of the electronic device. Liquid crystal thermometers are commercially available from a wide variety of sources, and are typically encased in a plastic strip that changes color to indicate different temperature ranges. They provide an advantage in that they are small, thin, and lightweight. They can be integrated with the cooling sticker or installed as a separate unit.

Having discussed the invention in general, we turn now to a detailed discussion of the figures.

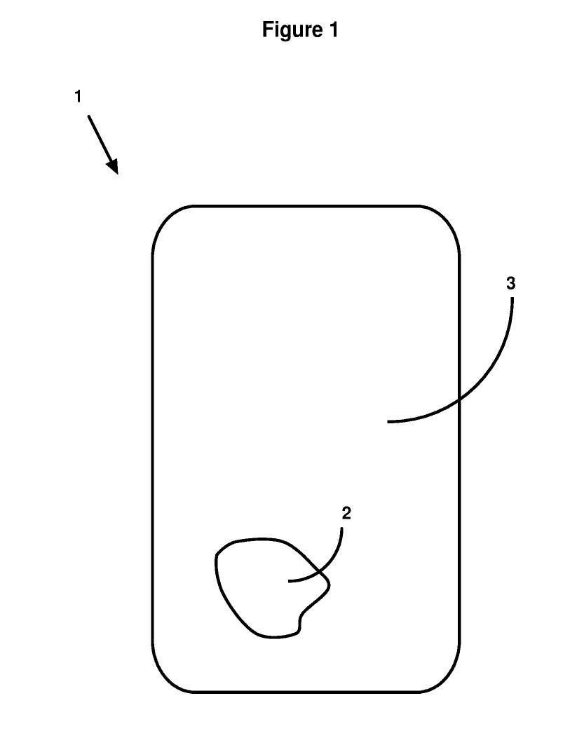

FIG. 1 illustrates a bottom plan view of a preferred embodiment of a cellular telephone 1 showing a hot spot 2 on the bottom surface 3 of the cellular telephone 1. Hot spots 2 can be caused by heat from the battery or other components of the computer that tend to produce excessive heat. Electronic devices need to operate within a predetermined temperature range, and heat will adversely affect a device's performance. However, heat is often limited to a relatively small area of the cellular telephone, usually by the battery. As shown in this figure, the hot spot 2 is concentrated in only a portion of the cellular telephone 1, but that is often all that is needed to cause device failure.

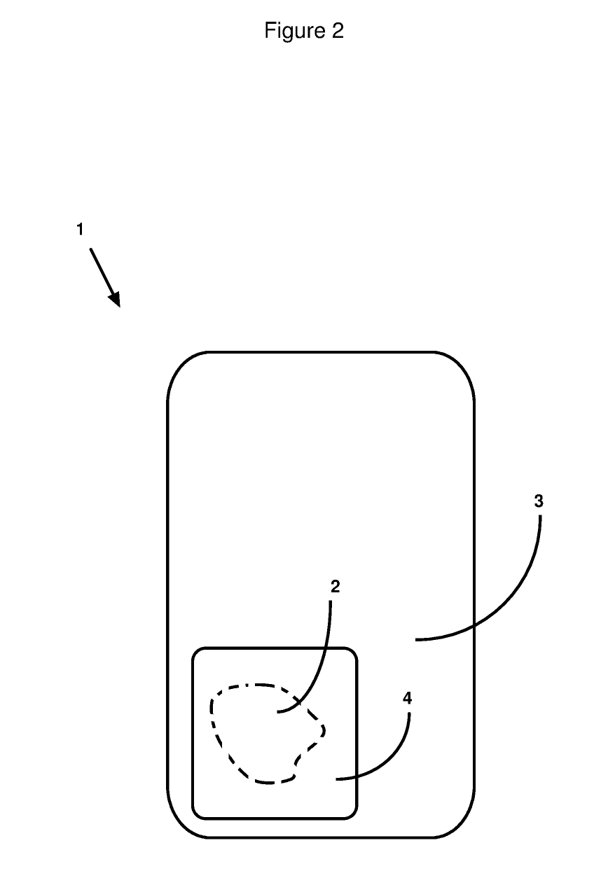

FIG. 2 illustrates a bottom plan view of a preferred embodiment of a cellular telephone 1 showing a cooling sticker 4 secured over the hot spot 2 (shown in dashed lines in this figure). In this configuration, the cooling sticker 4 draws heat from the hot spot 2, while the rest of the cellular telephone 1, which is not excessively hot, does not require any thermal relief.

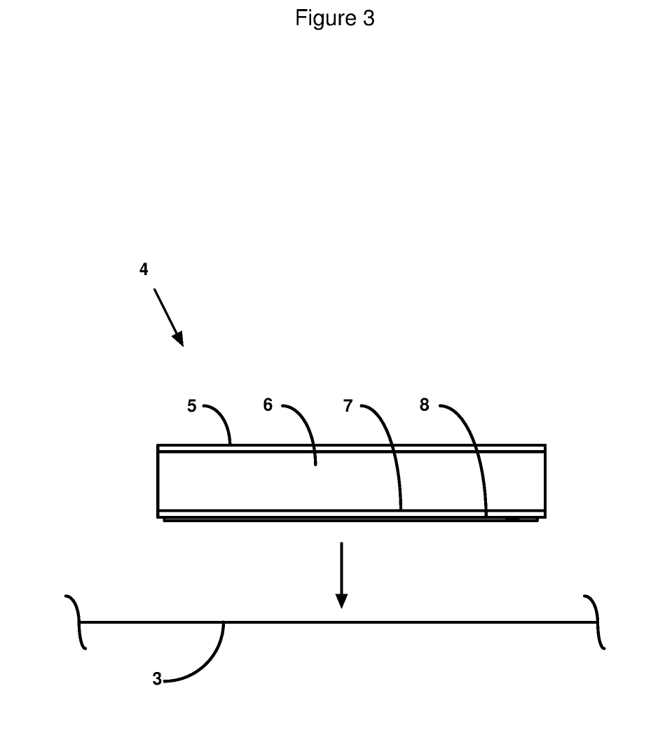

FIG. 3 illustrates an edge view of a preferred embodiment of the cooling sticker 4 showing the layered structure. The insulation layer 5 is shown on the distal surface of the cooling sticker 4. Beneath that is the core layer 6 that absorbs heat from the cellular telephone 1. On the proximal surface of the cooling sticker 4 is the heat transfer layer 7 that can be a metalized mylar or other foil to maximize heat transfer from the cellular telephone 1 to the core layer 6. An attachment layer 8 is also shown. The attachment layer 8 secures the cooling sticker 4 to the cellular telephone 1. Any form of suitable adhesive can be used so long as it allows the cooling sticker 4 to be conveniently installed and removed.

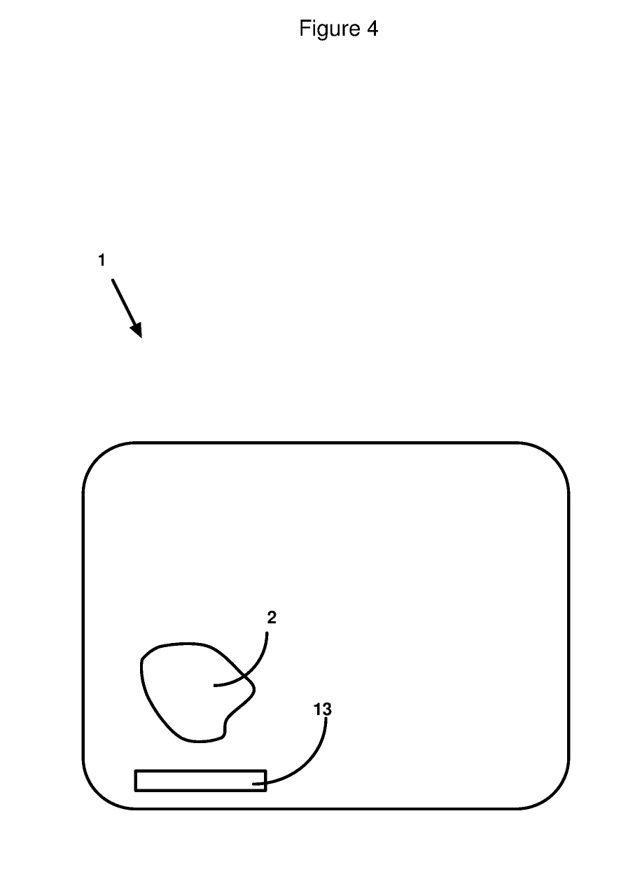

FIG. 4 illustrates a rear view of a cellular telephone 1 with a thermal strip 13 for indicating the temperature of the cellular telephone 1 at the location that is prone to heat, typically at the location of the battery.. This figure shows the thermal strip 13 secured directly to the surface of the cellular telephone 1. This allows the thermal strip 13 to be permanently mounted to the device 1. However, those skilled in the art will recognize that the thermal strip 13 could also be integrated with the cooling sticker 4.

While specific embodiments have been discussed to illustrate the invention, it will be understood by those skilled in the art that variations in the embodiments can be made without departing from the spirit of the invention. The types of materials used can vary, the method of attachment can vary, etc. For example, the phase change material can be any PCM material and does not have to be limited to the particular PCM material used above. The material used to fabricate the insulating layer and the heat transfer layer can vary. Therefore, the invention shall be limited solely to the scope of the claims.

I claim:

1. A detachable cooling sticker for cellular telephones, comprising:
a detachable cooling sticker sized to fit a hotspot on an cellular telephone, such that when the cooling sticker is in contact with the hot spot, heat is transferred from the hotspot to the cooling sticker, the cooling sticker further comprising:
a distal surface facing away from the cellular telephone, the distal surface comprised of insulating material;
a core layer comprised of heat absorbing material;
a proximal surface facing toward the cellular telephone;
an attachment layer to removably secure the cooling sticker to the cellular telephone;
whereby the core layer transfers excessive heat away from the hotspot on the cellular telephone to the core layer.

2. A cooling sticker, as in claim 1, wherein:
the core layer is comprised of phase change material.

3. A cooling sticker, as in claim 2, wherein:
the distal layer is secured to the distal surface of the core layer.

4. A cooling sticker, as in claim 2, further comprising:
a proximal layer secured to the proximal surface of the core layer, and comprised of material having a high thermal conductivity.

5. A cooling sticker, as in claim 4, wherein:
the proximal layer is substantially comprised of metalized Mylar.

6. A cooling sticker, as in claim 3, wherein:
the insulating material in the distal layer substantially comprised of Lumira Aerogel.

7. A cooling sticker, as in claim 2, wherein:
the phase change material in the core layer is substantially comprised of graphine nano-platelets and polyaniline material.

8. A cooling sticker, as in claim 1, wherein:
the attachment layer on the proximal surface of the cooling device is an adhesive layer.

9. A method of extracting heat from a hotspot on cellular telephones, including the steps of:
detachably connecting a cooling sticker sized to fit over a hotspot on a cellular telephone; and
using phase change material in the cooling sticker as the active heat extraction material such that when the cooling sticker is in contact with the hot spot, heat is transferred from the hotspot into the phase change material in the cooling sticker;
whereby the phase change material transfers heat from the hotspot on the cellular telephone to the cooling sticker.

10. A method, as in claim 9, including the additional step of:
using graphine nano-platelets and polyaniline material as the phase change material.

11. A method, as in claim 10, including the additional step of:
using a layer of material having a high thermal conductivity between the cooling pad and the device.

12. A method, as in claim 11, including the additional step of:
using a metalized Mylar as the layer of material having a high thermal conductivity.

13. A method, as in claim 11, including the additional step of:
using Lumira Aerogel to insulate the surface of the cooling pad that does not come in contact with the cellular telephone.
